(19) United States
(12) Patent Application Publication
(10) Pub. No.: US 2007/0213158 A1
(43) Pub. Date: Sep. 13, 2007

(54) Drive Train for a Motor Vehicle and Control Method Thereof

(75) Inventor: Jacques Laeuffer, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, VELIZY-VILLACOUBLAY (FR)

(21) Appl. No.: 10/556,870

(22) PCT Filed: May 14, 2004
(86) PCT No.: PCT/FR04/01196

§ 371 Date: Feb. 16, 2007

(30) Foreign Application Priority Data
May 16, 2003 (FR) 03/05922

(51) Int. Cl. F16H 3/72; B60W 20/00

(52) U.S. Cl. 475/5; 903/903

(57) ABSTRACT

The invention relates to a drive train comprising a first electrical machine (15) having a first stator and a first rotor, a propulsion shaft (19) driven in rotation by the first rotor, energy storage means (27, 35), and electrical energy distribution means (26) electrically connecting the first stator to the energy storage means (27, 35). The energy storage means (27, 35) comprise a second electrical machine (27) having a second rotor and a second stator, connected firstly electrically to the energy distribution means (26), and secondly mechanically by a shaft (37) to a flywheel (35) of small dimensions. The invention also provides a method of controlling such a drive train and applies to propelling hybrid motor vehicles.

The present invention relates to a motor vehicle drive train and also to a method of controlling such a drive train.

As is well known, the efficiency of engines for propelling motor vehicles is a function of the power being delivered. Thus, if the power being delivered is zero or low, e.g. while stationary or during initial stages after starting, then efficiency is low, in particular because of idling. As a result, for journeys in an urban environment where the vehicle performs numerous stop/start operations, the consumption of fuel or of electrical energy is very high.

Furthermore, while the vehicle is slowing down prior to stopping, the kinetic energy accumulated by the vehicle is completely lost.

In order to minimize consumption, hybrid vehicles with a power battery have been developed. Such vehicles comprise an engine, and an electrical machine for rotating the drive shaft. The electrical machine is electrically connected to a power battery.

While such a vehicle is decelerating, the electrical machine operates as an alternator and stores electricity in the power battery. When the vehicle restarts, the engine is off. The power battery then supplies the electrical energy needed to drive the electrical machine. The machine then operates as a motor driving the propulsion shaft of the vehicle, e.g. for about 30 seconds (s) until the engine is restarted.

Such vehicles enable fuel consumption to be reduced considerably, particularly for journeys in an urban environment.

Nevertheless, vehicles of that type do not give entire satisfaction. In order to store the electrical power needed for driving the electric motor when starting the vehicle, the associated power batteries are heavy and bulky. Furthermore, such batteries are very expensive and of limited lifetime, which means they need to be replaced frequently.

A main object of the invention is to remedy that drawback by proposing a drive train for a hybrid motor vehicle that presents low fuel consumption, at low cost.

To this end, the invention provides a motor vehicle drive train of the type comprising:

a first electrical machine comprising a first stator and a first rotor;

a propulsion shaft rotated by the first rotor;

energy storage means; and

electrical energy distribution means electrically connecting the first stator to the electrical energy storage means;

the drive train being characterized in that the energy storage means comprise:

a second electrical machine comprising a second rotor and a second stator, connected firstly electrically to the energy distribution means, and secondly mechanically via a shaft to a flywheel of small dimensions.

According to other characteristics of the invention:

the diameter of the flywheel lies in the range 10 centimeters (cm) to 25 cm;

the mass of the flywheel lies in the range 5 kilograms (kg) to 10 kg;

the electrical energy distribution means comprise a first inverter electrically connected firstly to the first stator and secondly to a filter capacitor; and a second inverter electrically connected firstly to the filter capacitor and secondly to the second stator;

it further comprises an engine provided with an outlet shaft that is mechanically connected to the propulsion shaft;

the first rotor is mechanically connected firstly to the outlet shaft of the engine via a clutch, and secondly to the propulsion shaft;

the outlet shaft of the engine is secured to the propulsion shaft and is connected to the first rotor by transmission means;

the outlet shaft of the engine, the propulsion shaft, and the first rotor are mechanically connected to a first epicyclic gear;

it further comprises a third electrical machine electrically connected to the distribution means and mechanically connected firstly to the propulsion shaft, and secondly to a second epicyclic gear; this second epicyclic gear being connected to the outlet shaft of the engine;

the mechanical connection between the third electrical machine and the propulsion shafts and the second epicyclic gear comprises a claw connection;

the energy storage means comprise a fuel cell.

The invention also provides a motor vehicle fitted with a drive train as described above.

The invention also provides a method of controlling a drive train as described above, the method being characterized in that it comprises the following stages:

a) a vehicle starting stage in which:
the engine is maintained in the off state;
the electrical energy stored by the flywheel is converted into electrical energy for powering the first electrical machine;
the shaft for propelling the wheels of the vehicle is driven using the first rotor; and then

b) an end-of-acceleration stage for the vehicle, in which:
the engine is started;
the first electrical machine is caused to operate as an alternator; and
the electrical energy produced is converted into mechanical energy that is stored by the flywheel.

Other characteristics and advantages of the invention appear from the following description given by way of example and made with reference to the accompanying drawings, in which:

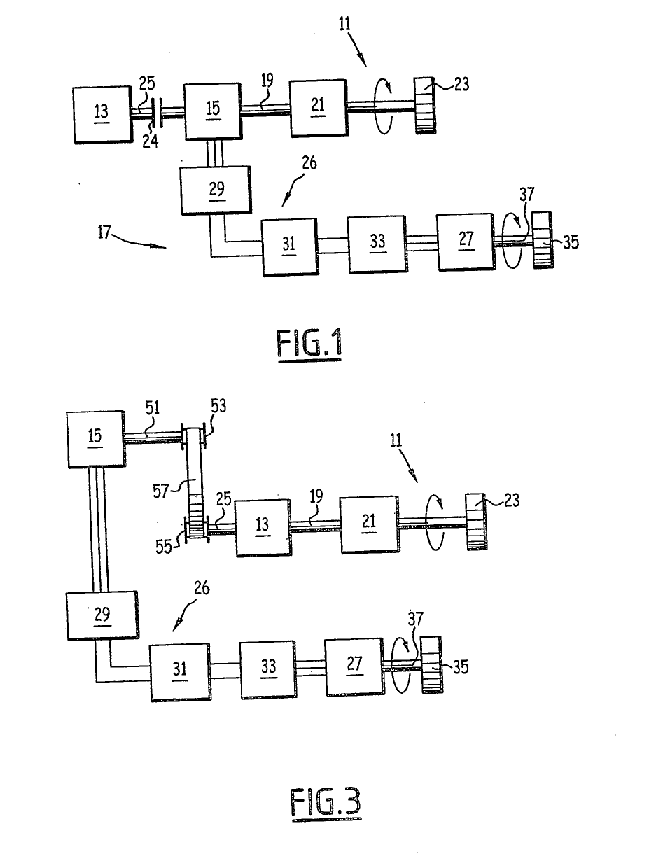

FIG. 1 is a diagram showing the main elements of a first drive train of the invention;

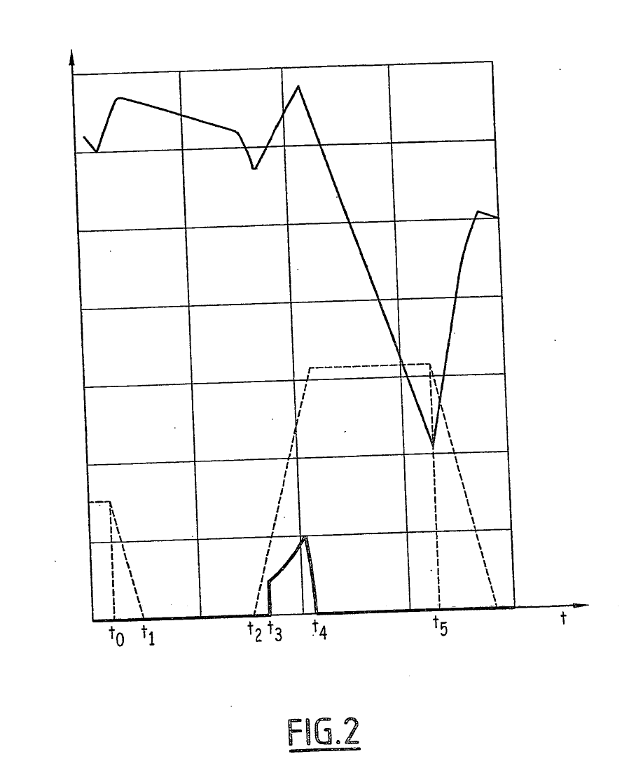

FIG. 2 is a plot of the stored energy, the vehicle speed, and the consumption of the engine as a function of time when starting a vehicle fitted with the drive train of FIG. 1;

FIG. 3 is a diagram showing the main elements of a second drive train of the invention;

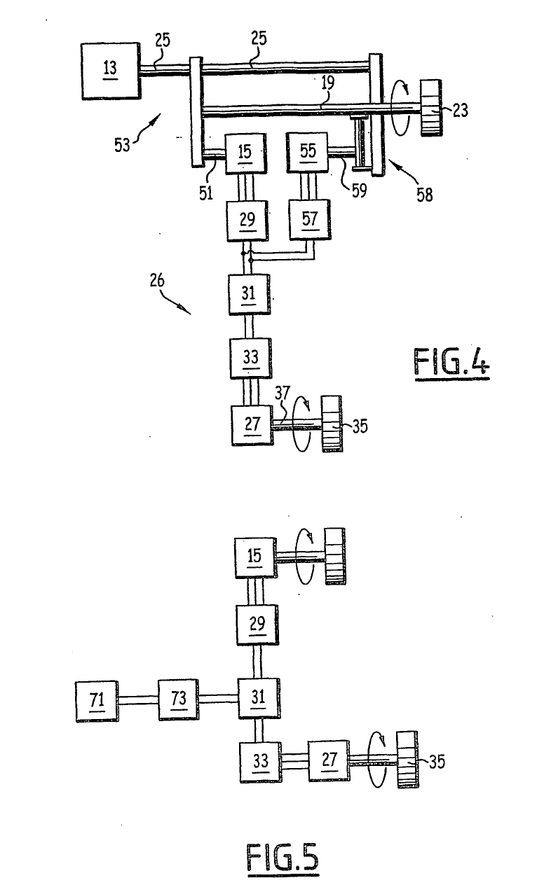

FIG. 4 is a diagram showing the main elements of a third drive train of the invention; and

FIG. 5 is a diagram showing the main elements of a fourth drive train of the invention.

FIG. 1 is a diagram showing the elements of a drive train for a hybrid motor vehicle. The drive train comprises a propulsion assembly 11 rotated by an engine 13 and/or a first electrical machine 15 provided with a power supply assembly 17.

The propulsion assembly 11 has a propulsion shaft 19 and a mechanical power transmission 21 comprising a gearbox and a clutch (not shown) connected to the wheels 23 of the vehicle.

The engine 13 is provided with an outlet shaft 25 which is rotated by burning gasoline or natural gas in the cylinders of the engine 13.

The first electrical machine 15 comprises a rotor and a stator. The rotor is connected mechanically firstly to the propulsion shaft 19, and secondly to the outlet shaft 25 from the engine 13 via a clutch 24. In the configuration shown in FIG. 1, the electric motor 15 is disposed between the engine 13 and the transmission 21.

The clutch 24 allows the engine 13 to be stopped completely while it is not in use.

The first electrical machine 15 operates as a motor driving the rotor when the stator is electrically powered. It operates as an alternator for recovering from the terminals of the stator the electrical energy that is induced by rotation of the rotor while the stator is not electrically powered.

The power supply assembly 17 comprises a distributor 26 and a second electrical machine 27.

The distributor 26 comprises a first inverter 29, a filter capacitor 31, and a second inverter 33.

The first inverter 29 is electrically connected to the stator of the first electrical machine 15 via a three-phase alternating current (AC) connection. The first inverter 29 is also connected to the filter capacitor 31 via a direct current (DC) connection. The inverter 29 converts the AC received from the first stator into DC for charging the capacitor 31 whenever the first electrical machine is operating as an alternator. It also serves to convert the DC delivered by the filter capacitor 31 into AC that is delivered to the first stator while the first electrical machine 15 is operating as a motor.

The filter capacitor 31 is charged to a DC voltage, firstly by the first inverter 29, and secondly by the second inverter 33. The maximum power to be recovered on starting is less than 20 kilowatts (kW) and is substantially equal to 10 kW. As a result, the voltage across the terminals of the capacitor is maintained at a value that is greater than 300 volts (V), and that is preferably substantially equal to 400 V.

The second inverter 33 is electrically connected firstly to the filter capacitor 31 via a DC connection, and secondly to the second electrical machine 27 via a three-phase AC connection. This inverter 33 is identical to the first inverter 39.

The second electrical machine 27 comprises a stator, and a rotor, and it is provided with a flywheel 35 of small size.

The second stator is connected to the second inverter 33 via a three-phase AC connection.

The rotor is mechanically connected to a drive shaft 37 for driving the flywheel 35.

The flywheel 35 is of small dimensions. Its diameter lies in the range 10 cm to 25 cm and preferably in the range 15 cm to 20 cm. Its mass lies in the range 5 kg to 10 kg. Its dimensions enable it to store energy substantially equal to 100 kilojoules (kJ) in the form of rotary mechanical energy.

Like the first electrical machine 15, the second electrical machine 27 operates as a motor for propelling the flywheel 35 when the second stator is electrically powered. It operates as an alternator for picking up the electrical energy induced by the rotation of the rotor from the terminals of the stator when the stator is not powered.

An example of the operation of the first drive train of the invention is described below starting from a stage of vehicle deceleration.

During such deceleration, the first electrical machine 15 operates as an alternator and the engine 13 is off. The wheels 23 rotate the propulsion shaft 19 and consequently rotate the first rotor of the first electrical machine 15. This rotation induces three-phase AC at the terminals of the stator, which AC is picked up by the first inverter 29. The first inverter 29 then operates as a rectifier, transferring the electrical energy generated by the first machine 15 to the filter capacitor 31.

The voltage across the terminals of the filter capacitor 31 thus tends to increase. As a reaction to this increase in voltage, the second inverter 33 converts the electrical energy received by the capacitor 31 into three-phase AC which is transferred to the second electrical machine 27.

This second electrical machine 27 then operates as a motor, rotating the flywheel 35. The electrical energy received by the second electrical machine 27 is thus converted into rotary mechanical energy and is stored by the flywheel 35.

As shown in FIG. 2, between times t₀ and t₁, the speed of the vehicle decreases (dashed line), and the energy stored by the flywheel 35 increases (fine line), while the fuel consumption of the engine 13 is zero (bold line).

Between times t₁ and t₂ the vehicle is stopped. The flywheel 35 slows down a little, and the mechanical energy stored by the flywheel 35 decreases slightly. At time t₂, the vehicle restarts. The engine 13 is still off. The rotation of the flywheel 35 generates three-phase AC at the terminals of the second machine 27 which is transferred to the second inverter 33. The second inverter 33 transfers the energy it receives in electrical form to the filter capacitor 31. The voltage across the terminals of the capacitor 31 thus tends to increase.

As a reaction to this increase in voltage, the first inverter 29 converts the electrical energy it receives into three-phase AC which is transferred to the stator of the first machine 15. This stator induces rotation of the first rotor and thus of the propulsion shaft 19, and under the action of the transmission 21 under the control of the driver, it rotates the wheels 23 of the vehicle. As shown in FIG. 2, the speed of the vehicle (dashed line) increases progressively while the mechanical energy stored by the flywheel 35 decreases.

At time t₃, the engine 13 is started in order to supply the mechanical energy needed to complete the acceleration of the vehicle. The first electrical machine then operates as an alternator and the electrical energy received by said first machine is transferred to the flywheel as described above via the first inverter 29, the filter capacitor 31, the second inverter 33, and the second machine 27. The mechanical energy stored by the flywheel 35 then increases as shown in FIG. 2.

At time t₄, the vehicle reaches the desired speed. The engine 13 is then switched off. The first electrical machine 15 operates as a motor for maintaining the vehicle at the desired speed. The electrical power supply to the first electrical machine 15 is delivered as described above by transferring mechanical energy stored in the flywheel 35 while in the form of electrical energy through the second electrical machine 27, the second inverter 33, the filter capacitor 31, and the first inverter 29. As shown in FIG. 2, the energy stored by the flywheel 35 decreases during this stage until time t₅ when a new stage of vehicle deceleration begins.

As shown in FIG. 2, the time during which the engine 13 is running is considerably shorter than the total time of the deceleration/stop/start cycle. The fuel consumption of the vehicle fitted with this first drive train of the invention is thus very small.

The principle elements of a second drive train of the invention are shown in FIG. 3. Unlike the drive train shown in FIG. 1, the propulsion shaft 19 is secured to the outlet shaft 25 of the engine 13. Furthermore, the first rotor of the first electrical machine is secured to a drive shaft 51. This drive shaft 51 is offset from the outlet shaft 25 of the engine 13. Each of these two shafts 13, 51 carries a respective transmission pulley wheel 53, 55, the pulley wheels facing each other. These transmission pulley wheels 53, 55 are interconnected by an endless transmission member 57 such that rotation of one out of the drive shaft 51 of the first electrical machine 15 and the outlet shaft 25 of the engine 13 causes the other shaft to rotate as well.

The operation of the second drive train of the invention is similar to the operation of the drive train shown in FIG. 1.

FIG. 4 shows a third drive train of the invention. Unlike the drive train shown in FIG. 1, this drive train further includes a first epicyclic gear 53 and a third electrical machine 55 associated with a third inverter 57 and a second epicyclic gear 58.

The first epicyclic gear 53 comprises a ring, a sunwheel, and a planet carrier. The outlet shaft 25 of the engine 13, the rotor of the first electrical machine 15, and the propulsion shaft 19 are each connected to one of the outlets of the first epicyclic gear 53.

The third electrical machine 55 comprises a third rotor and a third stator. The third rotor is secured to a link shaft 59. The third stator is electrically connected to the third inverter 57 via a three-phase AC electrical connection. The third inverter 57 is electrically connected to the filter capacitor 31 via a DC electrical connection.

The second epicyclic gear 58 comprises a second ring, a second sunwheel, and a second planet carrier. The outlet shaft 25 of the engine is secured to one of the outlets of the second epicyclic gear 58. The link shaft 59 of the third electrical machine 55 is also in connection firstly with the propulsion shaft 19 and secondly with another outlet of the second epicyclic gear 59 via a claw type connection.

The operation of this third drive train of the invention is similar to that described in French patent application No. 01/15050 filed in the name of the Applicant, having added thereto the flywheel energy storage means identical to that of FIGS. 1 to 3.

In this drive train, the gear ratio between the engine 13 and the wheels 23 is variable with full continuity of torque and speed.

In the variant shown in FIG. 5, the engine is replaced by a fuel cell 71 electrically connected to a capacitor 73. The capacitor 73 is also electrically connected to the filter capacitor 31.

During the acceleration of the vehicle, between times t₃ and t₄ in FIG. 2, the fuel cell 71 is activated and converts chemical potential energy into electrical energy. This electrical energy is transferred to the first inverter 29. The inverter 29 converts this electrical energy into three-phase AC. The three-phase AC powers the first stator of the first electrical machine 15. This power supply drives the first rotor in rotation and consequently rotates the propulsion shaft.

This type of drive train is used with fuel cells 71 that respond after a delay on being powered up. Thus, during this stage of powering up the fuel cell, the energy stored in the flywheel 35 provides the energy needed to propel the vehicle.

By means of the invention as described above, a drive unit is obtained for a hybrid vehicle that presents low fuel consumption and that is of smaller cost than a drive train for a hybrid vehicle as has been used until now.

This drive train presents the advantage of being relatively compact and of being easily adapted to various architectures of hybrid vehicle.

Furthermore, this type of drive train can operate advantageously in the presence of a fuel cell.

Furthermore, the moment of inertia of the flywheel 35 advantageously lies in the range 6×10⁻³ kilogram meters squared (kg·m²) to 8×10⁻² kg·m².

The moment of inertia of the flywheel is preferably substantially equal to 5×10⁻² kg·m².

1. A motor vehicle drive train of the type comprising:
a first electrical machine comprising a first stator and a first rotor;
a propulsion shaft rotated by the first rotor;
energy storage means; and
electrical energy distribution means electrically connecting the first stator to the electrical energy storage means;
wherein the energy storage means comprise:
a second electrical machine comprising a second rotor and a second stator, connected firstly electrically to the energy distribution means, and secondly mechanically via a shaft to a flywheel of small dimensions, and wherein the drive train further comprises an engine provided with an outlet shaft that is mechanically connected to the propulsion shaft.

2. A drive train according to claim 1, wherein the diameter of the flywheel lies in the range 10 cm to 25 cm.

3. A drive train according to claim 1, wherein the mass of the flywheel lies in the range 5 kg to 10 kg.

4. A drive train according to claim 1, wherein the electrical energy distribution means comprise a first inverter electrically connected firstly to the first stator and secondly to a filter capacitor; and a second inverter electrically connected firstly to the filter capacitor and secondly to the second stator.

5. A drive train according to claim 4, wherein the first rotor is mechanically connected firstly to the outlet shaft of the engine via a clutch, and secondly to the propulsion shaft.

6. A drive train according to claim 4, wherein the outlet shaft of the engine is secured to the propulsion shaft and is connected to the first rotor by transmission means.

7. A drive train according to claim 4, wherein the outlet shaft of the engine, the propulsion shaft, and the first rotor are mechanically connected to a first epicyclic gear.

8. A drive train according to claim 7, further comprising a third electrical machine electrically connected to the distribution means and mechanically connected firstly to the propulsion shaft, and secondly to a second epicyclic gear; this second epicyclic gear being connected to the outlet shaft of the engine.

9. A drive train according to claim 8, wherein the mechanical connection between the third electrical machine and the propulsion shafts and the second epicyclic gear comprises a claw connection.

10. A drive train according to claim 1, wherein the energy storage means comprise a fuel cell.

11. A motor vehicle fitted with a drive train according to claim 1.

12. A method of controlling a motor vehicle drive train according to claim 1, the method comprising the following stages:
a) a vehicle starting stage in which:
the engine is maintained in the off state;
the electrical energy stored by the flywheel is converted into electrical energy for powering the first electrical machine;
the shaft for propelling the wheels of the vehicle is driven using the first rotor; and then
b) an end-of-acceleration stage for the vehicle, in which:
the engine is started;
the first electrical machine is caused to operate as an alternator; and
the electrical energy produced is converted into mechanical energy that is stored by the flywheel.

13. A method according to claim 12, wherein, when the vehicle reaches a desired speed, the method comprises:
a first stage in which the engine is switched off;
a second stage in which the first electrical machine is caused to operate as a motor to maintain the vehicle at the desired speed using the propulsion shaft; and
a third stage in which the mechanical energy stored by the flywheel is converted into electrical energy for powering the first electrical machine.

14. A method according to claim 12, comprising the following stages:
c) a vehicle deceleration stage, in which:
the engine is kept in the off state;
the first electrical machine is caused to operate as an alternator;
the electrical energy produced is converted into mechanical energy that is stored by the flywheel; and
d) a vehicle stop stage in which:
the engine is maintained in the off state.
